(19) United States
(12) Patent Application Publication
(10) Pub. No.: US 2026/0210491 A1
(43) Pub. Date: Jul. 23, 2026

(54) ELECTRONIC DEVICE BRACKET

(71) Applicant: Quan Ren, Shenzhen (CN)

(72) Inventor: Quan Ren, Shenzhen (CN)

(21) Appl. No.: 19/446,132

(22) Filed: Jan. 12, 2026

(30) Foreign Application Priority Data
Jan. 17, 2025 (CN) 202520121347.5

(51) Int. Cl. F16M 13/02; F16M 13/06; G02B 7/182

(52) U.S. Cl. CPC F16M 13/022; F16M 13/06; G02B 7/182

(57) ABSTRACT

Provided is an electronic device bracket, which includes a base, a suction cup panel, and a surface cover. The suction cup panel is provided on the base and includes a suction cup. The surface cover is rotatably connected to an edge of the base and is flipped relative to the base to switch between a first state, a second state, and a third state. In the first state, the surface cover is stacked on the base and covers a suction surface of the suction cup panel; in the second state, there is an angle between the surface cover and an installation surface; in the third state, the surface cover and the base are arranged side by side.

### CROSS-REFERENCE TO RELATED APPLICATIONS

This application claims the priority of a Chinese patent application submitted to the China National Intellectual Property Administration on Jan. 17, 2025, with an application number of 2025201213475 and entitled with “electronic device bracket and electronic device protective shell”, which is hereby incorporated by reference in its entirety.

### TECHNICAL FIELD

The present disclosure relates to the field of bracket technologies, and in particular, to an electronic device bracket.

### BACKGROUND

Electronic device protective shells are commonly used electronic device accessories. In order to free up users'hands, various brackets that are used in combination with electronic device protective shells have appeared on the market. The brackets are generally fixed to a back plate of the electronic device protective shells by magnetic attraction and bonding, and movement of the brackets is used to match different support directions to stably display the screen content of the electronic device to a user. After the brackets are fixed on the back plate of the electronic device protective shells, it can be supported on the support surface by magnetic suction, suction cups, etc. The suction cups are attached to the support surface. The brackets are lightweight and do not require additional supporting parts such as magnets. They are widely used in bracket support. However, suction cups generate negative pressure inside the suction cups by compressing air, and many suction cups are exposed and prone to dust adhesion, which will cause unstable adsorption.

### SUMMARY

The present disclosure aims to provide an electronic device bracket to solve a technical problem of unstable adsorption caused by exposed the suction cup that is prone to dust adhesion.

The present disclosure discloses an electronic device protective shell, including:
a base, which is provided with a fitting surface and an installation surface that are arranged to be opposite to each other;
a suction cup panel, which is provided on the installation surface and includes one or more suction cups;
a surface cover, which is rotatably connected to an edge of the base and is configured to flip relative to the base to switch between a first state, a second state, and a third state; when in the first state, an angle between the surface cover and the installation surface is 0°; the surface cover is stacked on the base and covers an suction surface of the suction cup panel; in the second state, the angle between the surface cover and the installation surface is greater than 0° and less than 180°; in the third state, the angle between the surface cover and the installation surface is 180 degrees, the surface cover and the base are arranged side by side.

From the above technical solution, it can be seen that the embodiments of the present disclosure have at least the following advantages and positive effects.

The embodiment of the present disclosure provides the electronic device bracket, the protective base, the suction cup panel, and the surface cover are provided between the electronic devices, and the suction cup panel is provided on the base and faces the surface cover. The surface cover can be flipped relative to the base to switch between the first, second, and third states. In the first state, the surface cover is stacked on the base and covers the suction surface of the suction cup panel; in the second state, there is an angle between the surface cover and the installation surface, and the surface cover can support the electronic device or electronic device protective shell on the support surface; in the third state, the surface cover and base are arranged side by side and the suction cup panel can adhere to the support surface. The electronic device bracket of the present disclosure can change the shape of the electronic device bracket when the surface cover is flipped relative to the base, and transform different support methods to adapt to more support scenarios of electronic device brackets, thereby greatly improving the practicality of the electronic device bracket. On the other hand, in the first state of the surface cover, the surface cover is placed on the suction surface of the suction panel, which can provide dust prevention for the suction cup.

### BRIEF DESCRIPTION OF DRAWINGS

In order to illustrate the technical solutions of the embodiments of the present disclosure or of the prior art more clearly, the following drawings are briefly described as required in the context of the embodiments or the prior art. Obviously, the following drawings illustrate only some of the embodiments of the present disclosure. Other relevant drawings may be obtained on the basis of the shown structures of these drawings without any creative effort by those skilled in the art.

FIG. 1 is a schematic diagram of an assembly structure of an electronic device bracket and an electronic device according to an embodiment of the present disclosure.

FIG. 2 is a schematic diagram of an explosive structure of the electronic device bracket shown in FIG. 1.

FIG. 3 is a second state diagram of the electronic device bracket shown in FIG. 1.

FIG. 4 is a third state diagram of the electronic device bracket shown in FIG. 1.

FIG. 5 is another perspective view of the assembly diagram shown in FIG. 1.

FIG. 6 is a schematic diagram of a cross-sectional structure along A-A direction in FIG. 5.

FIG. 7 is a partially enlarged schematic diagram of the cross-sectional view shown in FIG. 5.

FIG. 8 is a schematic diagram of a cross-sectional structure along B-B direction in FIG. 5.

Numeral reference: 10—electronic device bracket; 11—base; 111—fitting surface; 112—installation surface; 113—first placement slot; 114—first installation groove; 12—suction cup panel; 121—suction cup; 122—installation panel; 13—surface cover; 131—second placement slot; 132—annular limit groove; 133—second installation groove; 14—sealing ring; 15—magnetic attraction component; 151—first magnet; 152—second magnet; 153—buffer pad; 16—flat mirror; 17—rotating component; 171—installation block; 172—first rotating shaft; 173—second rotating shaft; 18—annular magnet; 19—positioning protrusion; 20—electronic device.

### DESCRIPTION OF EMBODIMENTS

Typical embodiments reflecting features and advantages of the present disclosure will be described in detail in the following description. It should be understood that the present disclosure may admit to various modifications in different embodiments without departing from the scope of the present disclosure. The descriptions and drawings therein are substantially illustrative in nature rather than restrictive of the present disclosure.

Furthermore, the related terms “first”, and “second” are used for descriptive purposes only and are not to be understood as indicating or implying relative importance or implicitly specifying the number of technical features indicated. Thus, features defined as “first” or “second” may explicitly or implicitly include one or more of such features. In the description of the present application, the term “a plurality of” means two or more unless otherwise expressly specified.

In the description of the present application, it should be noted that terms such as “installed,” “provided,” and “connected” should be broadly understood unless otherwise expressly defined and limited. For example, a connection may be a fixed connection, a detachable connection, or an integral connection; may be a mechanical connection or an electrical connection; may be a direct connection or an indirect connection through an intermediate medium; and may be communication between interiors of two components. Those of ordinary skill in the art may understand the specific meanings of the above terms in the present disclosure based on practical contexts.

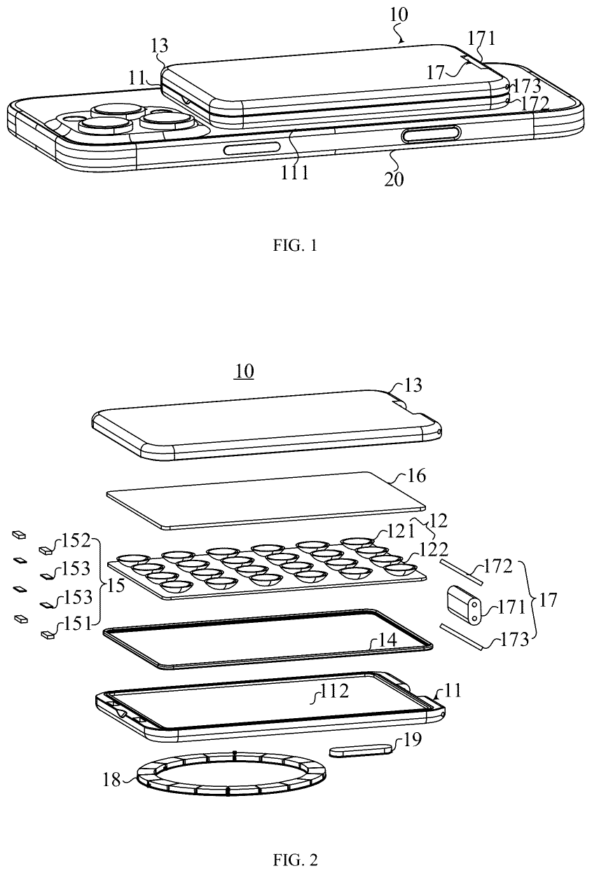

Referring to FIG. 1, the present disclosure provides a novel electronic device bracket 10. One side of the electronic device bracket 10 is provided on a back of the electronic device 20 or a protective shell, and the other side can be provided on other device or support surface to install or support the electronic device 20 on other devices, without the need for a user to hold the electronic device 20 for use, thus freeing up his hands. It should be noted that the electronic device 20 includes but is not limited to a mobile phone, a tablet, and a learning machine. The implementation of installing the electronic device bracket 10 on other devices includes but is not limited to methods such as adsorption, bracket support, buckle, and hanging.

Referring to FIGS. 1 and 2, the electronic device bracket 10 includes a base 11, a suction cup panel 12, and a surface cover 13. The base 11 has a fitting surface 111 and an installation surface 112 that are arranged opposite to each other. The fitting surface 111 is attached to the back of the electronic device or protective shell to install the electronic device bracket on the back of the electronic device 20, thereby providing support for the electronic device 20. The suction cup panel 12 is provided on the installation surface 112 and includes one or more suction cups 121. The suction cups 121 can adhere to a smooth support plane to attach the electronic device bracket 10 to a device with the smooth plane.

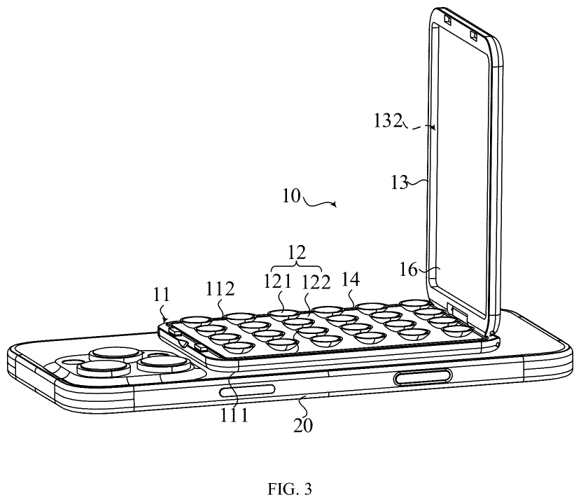

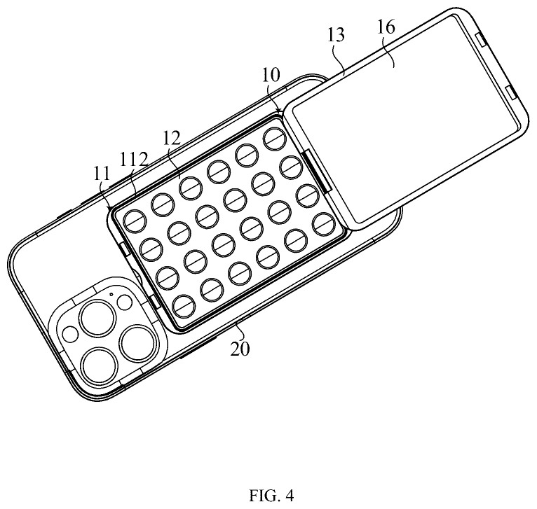

Referring to FIGS. 3 and 4, the surface cover 13 is rotatably connected to an edge of the base 11, and can be flipped relative to the base 11 to switch between a first state, a second state, and a third state. FIG. 1 illustrates that when the surface cover 13 is in the first state, an angle between the surface cover 13 and the installation surface 112 is 0°. The surface cover 13 is stacked on the base 11 and covers a suction surface of the suction cup panel 12. The surface cover 13 is covered to the suction cups 121 to prevent dust from entering the suction cups 121 and causing unstable suction of the suction cups 121. At this time, the suction cup panel 12 and the suction cups 121 are sandwiched and hidden between the base 11 and the surface cover 13. FIG. 3 illustrates that when the surface cover 13 is in the second state, an angle between the surface cover 13 and the installation surface 112 is greater than 0° and less than 180°, and the surface cover 13 is in an angle state with the base 11. The surface cover 13 can support the electronic device 20 or the protective shell on the support surface. It should be noted that the support surface here may not be smooth and flat. FIG. 4 illustrates that when the surface cover 13 is in the third state, the angle between the surface cover 13 and the installation surface 112 is 180°, and the surface cover 13 and the base 11 are arranged side by side. The suction cups 121 on the suction cup panel 12 can be attached to the support surface to support the electronic device 20 or the protective shell on the support surface through the suction cups 121. It should be noted that since the suction cups 121 are compressed by air to generate negative pressure inside the suction cups 121 and adsorb to the support surface, the support surface here is a smooth, flat, and clean surface.

The electronic device bracket 10 of the present disclosure can change the shape of the electronic device bracket that is flipped along with the surface cover 13 relative to the base 11, and transform different support methods to adapt to more support scenarios of the electronic device bracket 10, thereby greatly improving the practicality of the electronic device bracket 10. On the other hand, in the first state of the surface cover 13, the surface cover 13 is covered on the suction surface of the suction cup panel 12, which can provide dust prevention for the suction cups 121.

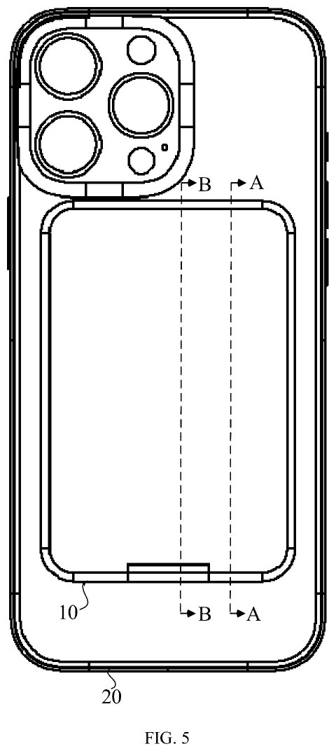

In an implementation mode, referring to FIGS. 2, 5, and 6, the electronic device bracket 10 includes a sealing ring 14. The sealing ring 14 is provided between the base 11 and the surface cover 13. When the angle between the surface cover 13 and the installation surface 112 is 0°, the sealing ring 14 surrounds the suction cup panel 12. A part of the installation surface 112, the sealing ring 14, and a part of the surface cover 13 are enclosed to form a closed space, and the suction cup panel 12 is provided within the closed space. The sealing ring 14 is configured to enhance a sealing performance of a side circumference of the surface cover 13 when it is covered to the base 11, and to further prevent dust and water. It should be noted that in the present disclosure, the arrangement of the sealing ring 14 is not limited without considering the dust and water resistance of the side circumference. Furthermore, other means and methods that can seal the side circumference should also be within the protection scope of the present disclosure.

In an implementation mode, referring to FIGS. 2 and 7, the electronic device bracket 10 includes a magnetic attraction component 15, and the magnetic attraction component 15 includes a first magnet 151 and a second magnet 152. The first magnet 151 is provided on the installation surface 112, and the second magnet 152 is provided on an end face of the surface cover 13 facing the base 11. When the surface cover 13 is flipped towards the base 11, the first magnet 151 and the second magnet 152 are aligned and magnetically attracted, so that the surface cover 13 is covered to the installation surface 112. The sealing ring 14 is fixedly protruding from one of the installation surface 112 and the end face of the surface cover 13. The surface cover 13 is covered to the installation surface 112, and the sealing ring 14 undergoes an elastic deformation due to an attractive force between the first magnet 151 and the second magnet 152. The sealing ring 14 that undergoes the elastic deformation will release its elastic force to further press the end face, thereby sealing the side circumference of the surface cover 13 and the base 11. It should be noted here that the attractive force between the first magnet 151 and the second magnet 152 is greater than the elastic force released by the elastic deformation of the sealing ring 14, so that the sealing ring 14 will not push the surface cover 13 and maintain the state of being covered to the installation surface 112. The first magnet 151 and the second magnet 152 have the same number and are magnetically attracted to each other, and the number can be one or a plurality of. It should be noted that in the present disclosure, the alignment magnetic attraction between the first magnet 151 and the second magnet 152 has a positioning effect and provides sealing pressure for the sealing ring 14. In other embodiments, the magnetic attraction component 15 may not be provided.

In an implementation mode, referring to FIGS. 2 and 7, one side of the installation surface 112 is provided with a first placement slot 113, and the first magnet 151 is embedded in the first placement slot 113; the end face of the surface cover 13 is provided with a second placement slot 131, and the second magnet 152 is embedded in the second placement slot 131. Besides that, the magnetic attraction component 15 further includes a buffer pad 153, and the buffer pad 153 covers the first placement slot 113 or the second placement slot 131 to separate the first magnet 151 and the second magnet 152. On the one hand, it avoids contact friction and wear between the two, and on the other hand, the number of the buffer pads 153 is the same as the number of the magnets (first magnet 151 or second magnet) and placement slots (first placement slot 113 or second placement slot 131). One buffer pad 153 covers one magnet in one placement slot to protect the magnet. Furthermore, an outer surface of the buffer pad 153 does not protrude from an end face where the corresponding placement slot is located (the end face of the installation surface 112 or the surface cover 13). The buffer pad 153 can be embedded in a corresponding placement slot or flush with an end face where the corresponding placement slot is located, so that the installation surface 112 or the end face of the surface cover 13 can be seamlessly fitted as much as possible. It should be noted that, without considering the contact wear and exposed damage between the first magnet 151 and the second magnet 152, the arrangement of the placement slot and buffer pad 153 is not limited in the present disclosure.

In an implementation mode, referring to FIG. 7, the sealing ring 14 is fixedly protruding from one of the installation surface 112 and the end face of the surface cover 13, and the other of the installation surface 112 and the end face of the surface cover 13 are provided with an annular limit groove 132. When the surface cover 13 is covered to the installation surface 112, a protruding part of the sealing ring 14 is aligned with and engaged to the annular limit groove 132, and the sealing ring 14 is in interference fit with the annular limit groove 132 to achieve the sealing function of the sealing ring 14 (dustproof and waterproof). In this embodiment, it is not necessary to install the magnetic attraction component 15 to achieve the sealing function of the sealing ring 14. It should be noted that the sealing ring 14 can be integrally formed and processed on the corresponding end face, or it can be clamped into a limit groove of the corresponding end face through interference fit assembly.

In an implementation mode, referring to FIGS. 2 and 7, the installation surface 112 is provided with a first installation groove 114, and the suction cup panel 12 is embedded in the first installation groove 114. FIG. 2 illustrates that the suction cup panel 12 includes an installation panel 122 and a plurality of suction cups 121 in an array that are embedded on the installation panel 122. The installation panel 122 is recessed at different positions on its end face from the installation surface 112 towards the fitting surface 111, thereby forming the plurality of suction cups 121. A bottom of each of the suction cups 121 is in contact with a bottom wall of the first installation groove 114. Here, the arrangement of the installation panel 122 is to better secure the plurality of suction cups 121, so that the suction surface of the suction cup panel 12 is at the same horizontal plane. It should be noted that in the present disclosure, the number and formation method of the suction cups 121 are not limited, and the arrangement of the installation panel 122 is not limited.

In an implementation mode, referring to FIGS. 2 and 8, the electronic device bracket 10 includes a flat mirror 16, and a second installation groove 133 is provided on one side of the surface cover 13 facing the base 11. The flat mirror 16 is embedded into the second installation groove 133, and a mirror surface of the flat mirror 16 is arranged away from a bottom of the second installation groove 133. When the surface cover 13 is in the second state (FIG. 3) or the third state (FIG. 4), the flat mirror 16 is exposed for the user to use as a mirror. When the surface cover 13 is in the first state, that is, when the surface cover 13 is covered to the base 11, the suction cups 121 are attached to the mirror surface of the flat mirror 16. It should be noted that in the present disclosure, the arrangement of the flat mirror 16 and the second installation groove 133 are not limited.

In an implementation mode, referring to FIGS. 2 and 8, the electronic device bracket 10 includes a rotating component 17, and the rotating component 17 includes an installation block 171, a first rotating shaft 172, and a second rotating shaft 173. The first rotating shaft 172 sequentially passes through an edge side of the surface cover 13 and one side of the installation block 171, and the surface cover 13 is rotated relative to the installation block 171 around the first rotating shaft 172. The second rotating shaft 173 sequentially passes through the edge side of the base 11 and the other side of the installation block 171, and the base 11 rotates relative to the installation block 171 around the second rotating shaft 173. The first rotating shaft 172 and the second rotating shaft 173 are spaced apart and parallel to each other along a thickness direction of the base 11, so that the surface cover 13 is flipped relative to the base 11 around the first rotating shaft 172 and the second rotating shaft 173, and the angle between the surface cover 13 and the installation surface 112 varies between 0-180 degrees. It should be noted that in the present disclosure, any method or means that can achieve the rotating component 17 to change the angle between the surface cover 13 and the installation surface 112 between 0-180 degrees should be protected.

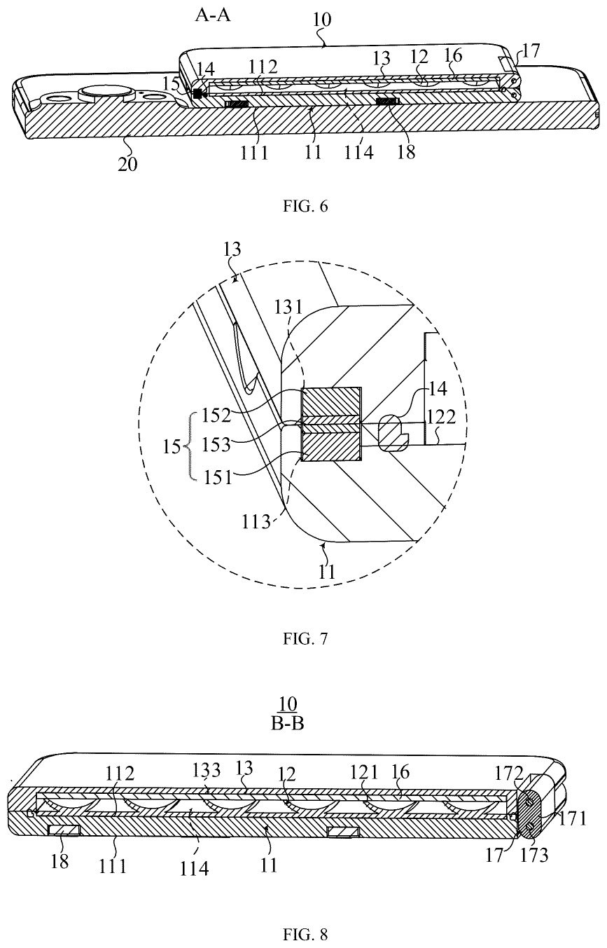

In an implementation mode, referring to FIGS. 2 and 6, the electronic device bracket 10 further includes an annular magnet 18 that is embedded in the fitting surface 111, and the annular magnet 18 magnetically attracts the electronic device bracket 10 to the back of the electronic device 20. Besides that, the fitting surface 111 of the electronic device bracket 10 is further provided with a positioning protrusion 19, and the positioning protrusion 19 is configured for positioning and installation of the protective shell with a positioning groove. It should be noted that in the present disclosure, any method or means of installing the electronic device bracket 10 on the back of the electronic device 20 or the back of the protective shell should be protected.

Although the present disclosure has been described with reference to several typical embodiments, it should be understood that the terminology used is illustrative and exemplary rather than restrictive. Since the present disclosure can be implemented in various forms without departing from its spirit or essence, it should be understood that the above-described embodiments are not limited by any foregoing details but should be broadly interpreted within the spirit and scope defined by the appended claims. Therefore, all changes and modifications falling within the scope of the claims or equivalents thereof should be covered by the appended claims.

What is claimed is:

1. An electronic device bracket, comprising:
a base, which is provided with a fitting surface and an installation surface that are arranged to be opposite to each other;
a suction cup panel, which is provided on the installation surface and comprises one or more suction cups;
a surface cover, which is rotatably connected to an edge of the base and is configured to flip relative to the base to switch between a first state, a second state, and a third state; when in the first state, an angle between the surface cover and the installation surface is 0°; the surface cover is stacked on the base and covers an suction surface of the suction cup panel; in the second state, the angle between the surface cover and the installation surface is greater than 0° and less than 180°; in the third state, the angle between the surface cover and the installation surface is 180 degrees, the surface cover and the base are arranged side by side.

2. The electronic device bracket according to claim 1, wherein the electronic device bracket further comprises a sealing ring, and the sealing ring is provided between the base and the surface cover;
when the angle between the surface cover and the installation surface is 0°, the sealing ring is configured to be surrounded by the suction cup panel;
the installation surface, the sealing ring, and the surface cover are enclosed to form a closed space, and the suction cup panel is provided in the closed space.

3. The electronic device bracket according to claim 2, wherein the electronic device bracket further comprises a magnetic attraction component, and the magnetic attraction component comprises a first magnet and a second magnet,
the first magnet is provided on the installation surface, and the second magnet is provided on an end face of the surface cover facing the base;
when the surface cover is flipped towards the base, the first magnet and the second magnet are aligned and magnetically attracted, so that the surface cover is covered to the installation surface;
the sealing ring is protruding from one of the installation surface and an end surface of the surface cover;
when the surface cover is covered on the installation surface, the sealing ring undergoes an elastic deformation due to an attractive force between the first magnet and the second magnet.

4. The electronic device bracket according to claim 3, wherein the installation surface is provided with a first placement slot, the first magnet is sleeved into the first placement slot,
wherein the surface cover is provided with a second placement slot, and the second magnet is sleeved into the second placement slot;
wherein the magnetic attraction component further comprises a buffer pad, and the buffer pad covers the first placement slot or the second placement slot.

5. The electronic device bracket according to claim 2, wherein the sealing ring is protruding from one of the installation surface and the end face of the surface cover, and the other of the installation surface and the end face of the surface cover is provided with an annular limit groove;
when the surface cover is covered to the installation surface, a protruding part of the sealing ring is aligned with and engaged to the annular limit groove, and the sealing ring is in interference fit with the annular limit groove.

6. The electronic device bracket according to claim 1, wherein the installation surface is provided with a first installation groove, and the suction cup panel is embedded in the first installation groove;
the suction cup panel comprises an installation panel and a plurality of suction cups in an array that are embedded in the installation panel;
the installation panel is recessed at different positions on its end face from the installation surface towards the fitting surface to form the plurality of suction cups;
a bottom of each of the suction cups is in contact with a bottom wall of the first installation groove.

7. The electronic device bracket according to claim 1, wherein the electronic device bracket further comprises a flat mirror, and a second installation groove is provided on one side of the surface cover facing the base;
the flat mirror is embedded into the second installation groove, and a mirror surface of the flat mirror is arranged away from a bottom of the second installation groove;
when the surface cover is covered onto the base, the suction cups are attached to the mirror surface of the flat mirror.

8. The electronic device bracket according to claim 1, wherein the electronic device bracket further comprises an installation block, a first rotating shaft, and a second rotating shaft;
the first rotating shaft sequentially passes through an edge side of the surface cover and the installation block, and the surface cover is rotated relative to the installation block around the first rotating shaft;
the second rotating shaft sequentially passes through an edge side of the base and the installation block, and the base is rotated relative to the installation block around the second rotating shaft;
the first rotating shaft and second rotating shaft are spaced apart and parallel to each other along a thickness direction of the base, so that the surface cover is configured to flip relative to the base around the first rotating shaft and second rotating shaft.

9. The electronic device bracket according to claim 1, wherein the electronic device bracket further comprises an annular magnet that is embedded in the fitting surface, and the annular magnet adsorbs the base to a back of the electronic device.

10. The electronic device bracket according to claim 9, wherein the fitting surface is provided with a positioning protrusion.
